(19) United States
(12) Patent Application Publication
(10) Pub. No.: US 2016/0203562 A1
(43) Pub. Date: Jul. 14, 2016

(54) System and Method for Notice Posting and Verification

(71) Applicant: Palmetto Posting, Inc., Spartanburg, SC (US)

(72) Inventor: Terry O'Brien, Spartanburg, SC (US)

(73) Assignee: Palmetto Posting, Inc., Spartanburg, SC (US)

(21) Appl. No.: 15/079,565

(22) Filed: Mar. 24, 2016

Related U.S. Application Data
(63) Continuation of application No. 12/119,192, filed on May 12, 2008.
(60) Provisional application No. 60/928,784, filed on May 11, 2007.

(51) Int. Cl. G06Q 40/00

(52) U.S. Cl. CPC G06Q 40/10; G06Q 50/18

(57) ABSTRACT

This invention includes a tax authority computer readable medium having a set of delinquent tax records wherein each delinquent tax record contains delinquent tax information representing a real estate property that has delinquent taxes; a posting computer readable medium in communications with the tax authority computer readable medium; a portable computer device having a portable computer readable medium and a digital image capturing device capable of communication with the posting computer readable medium; and computer readable instructions for receiving delinquent tax information, capturing a digital image of a tax notice posted, generating posting information including the date and time and the digital image, and transmitting the posting information to the posting computer readable medium.

### CLAIM OF PRIORITY

This application claims priority on U.S. Provisional Patent Application Ser. No. 60/928,784 filed May 11, 2007, entitled System and Method for Tax Notice Posting and Verification and is a continuation of U.S. patent application Ser. No. 12/119,192 filed May 12, 2008, entitled System and Method for Tax Notice Posting and Verification.

### FIELD OF THE INVENTION

This invention is directed to a system and method for notice posting and verification, and more specifically, to a system and method for recording the posting of legal notices such as a tax notice posting.

### BACKGROUND OF THE INVENTION

There are multiple legal notices that have to be posted under legal and administrative rules and regulations. For example, nearly every city, county or municipality in the United States employs a system for foreclosure upon properties where the property owners fail to pay any taxes due. The general practice is to send a field representative to the target property, whereby a tax notice is posted directly upon the property and the field representative thereafter fills out a form to verify that the tax notice was indeed posted upon the correct target property. Quite often, however, the property owner, through embarrassment or mere unwillingness to have a tax notice posted on their property, will immediately remove the tax notice from the target property. This presents a common dilemma for the local taxing authority who desires to be able to prove that the tax notice was posted on the correct property on the date certified by the field representative.

Currently, many taxing authorities employ a manual system which comprises printing a posting sheet to be used by a field representative. The posting sheet contains the address of the property and is associated with the tax notice which is also printed. When the field representative arrives at the target property, he places the tax notice on the property and then uses a camera, such as a Polaroid, to memorialize the posting. The Polaroid is then stapled to the form and the form is returned to the taxing authority. The taxing authority then must manually enter the information and file the Polaroid in a file that can correspond with the tax information for the target property. The system is subject to significant error as Polaroids can be unstapled from their forms, forms can be misfiled, and information can be incorrect on the form as well as in the system for associating the paper file with the tax file in the target system.

It would be advantageous to have a system and method for posting tax notices upon target properties that allows a field representative to memorialize that the posting occurred.

It would also be advantageous to have a system and method for assisting a field representative to identify and locate the target property for posting.

It would also be advantageous to have a system and method for reducing or eliminating the need for printed forms and Polaroid images.

### SUMMARY OF THE INVENTION

This invention is a tax notice posting system comprising: a portable computer device having a first computer readable medium, a display, and a digital image capturing device; a server having a second computer readable medium capable of communicating with the first computer readable medium; a set of delinquent tax records, each having delinquent tax information embodied in the second computer readable medium representing real estate properties that are associated with delinquent taxes, the delinquent tax information including the physical address of the real estate properties; a set of server computer readable instructions embodied in the second computer readable medium for selecting at least one delinquent tax record from the set of delinquent tax records, transmitting the delinquent tax information from the delinquent tax record to the portable computer device, receiving posting information from the portable computer device, associating the posting information with the delinquent tax record, updating the set of delinquent tax records reflecting that posting information has been received for the selected delinquent tax record so that proof of the tax notice posting is provided for the selected delinquent tax record; and, a set of portable computer device instructions embodied in the first computer readable medium for receiving the delinquent tax information from the server, displaying the physical address from the delinquent tax information on the display of the portable computer device, capturing a digital image with the digital image capturing device of a tax notice posted on the real estate property associated with the delinquent tax information, retrieving the date and time from the portable computer device, generating posting information including the date and time and the digital image, and transmitting the posting information to the server.

This invention can also include a GPS device included with the portable computer device and in communication with the first computer readable medium; and, the set of portable computer device instructions include instructions for retrieving the present location of the portable computing device when the digital image is captured and including the present location of the portable computing device in the posting information.

This invention can also include a printing device in communication with the portable computer device; and, the set of portable computer device instructions for printing a tax notice using the printing device so that a field representative is provided with a tax notice for posting after receiving the delinquent tax information.

This invention can also include a set of portable computer device instructions including instructions for receiving a signature from a field representative so that the posting information can be signed by the field representative and the set of portable computer device instructions includes instructions for determining a travel route for a field representative according to the physical addresses for each of the real properties represented by the delinquent tax records and displaying the travel route to the field representative on the display.

### DESCRIPTION OF THE DRAWINGS

The invention will be more readily understood from a reading of the following specification and by reference to the accompanying drawings:

FIG. 1 is an schematic of the invention;

FIG. 2 is a flowchart of the invention; and,

FIG. 3 is a flowchart of the invention.

### DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

The invention allows a field representative employed by a local taxing authority to post a tax notice (foreclosure) notice upon a target property and then memorialize that posting, to verify that posting did indeed occur, by taking a picture of the notice posted upon the property using a handheld cellular phone or personal data assistant (PDA) that includes a digital camera or other imaging device and entering posting information. Once the image is taken of the tax notice upon the foreclosure property, the field representative transmits that image and posting information directly over the Internet or other communication means to the taxing authority.

The posting information sent along with the digital image can include GPS coordinates and a date and time stamp to further verify that the notice was posted upon the correct property as well as an electronic or digital signature of the field representative, personally verifying that the information sent is correct and that the notice has been posted upon the foreclosure property. Once that information and image are received by the taxing authority, it can be stored on a taxing foreclosure database to meet any requirements necessary for the taxing authority to foreclose upon the target property.

The invention may be embodied in any of a number of systems that allow a field representative to take an image of the notice posted upon the target property and transmit that information to the local taxing authority. The invention may employ a variety of handheld devices including a digital camera, whereby the digital device may communicate with the taxing authority through a portable computer either wirelessly or using a handheld docking station. In one embodiment, the PDA may communicate directly with the taxing authority using a wireless connection through the Internet. The computer readable instructions necessary to accomplish these steps may be stored in a variety of locations, including the PDA, portable computer, tax authority server, or all of the above.

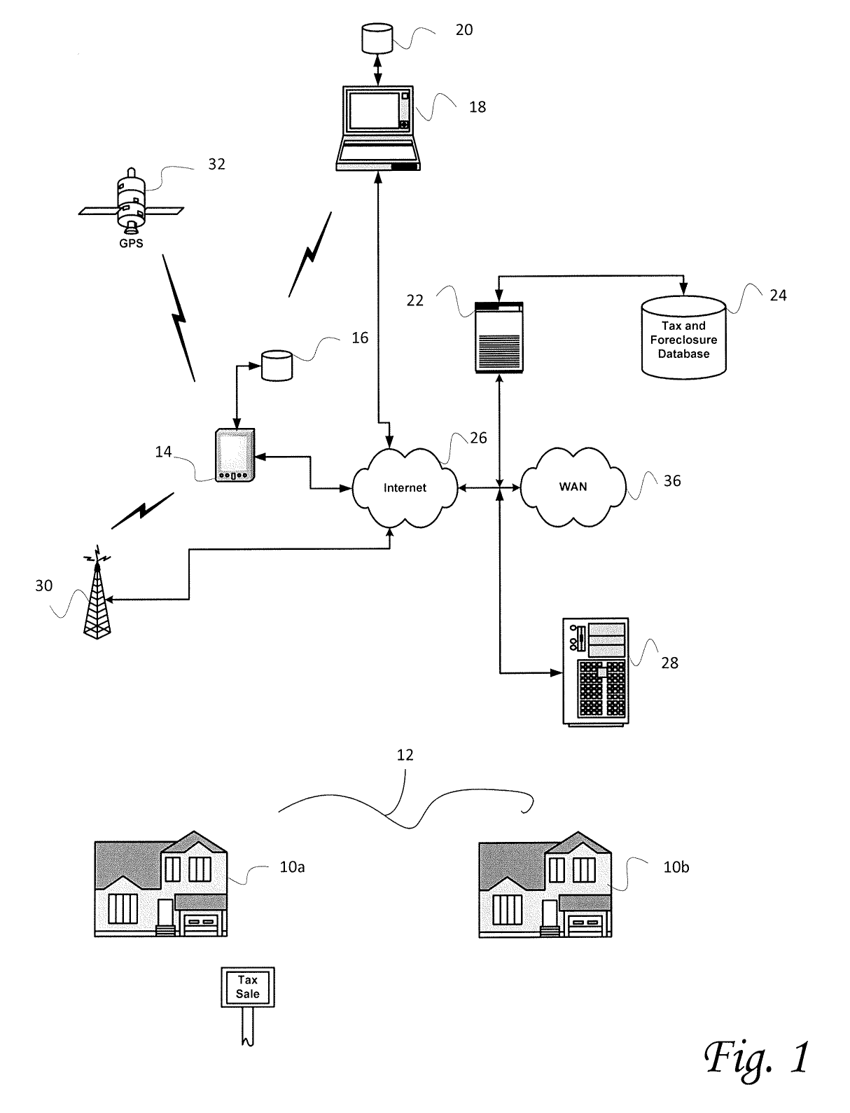

Referring now to FIG. 1, real estate property 10a has delinquent taxes. The taxing authority has a computer system 22 that contains delinquent tax records having delinquent tax information in database 24 that is in communication with the tax computer system 22. In one embodiment, the taxing authority's computer system is a server. One record in database 24 corresponds to real estate property 10b and indicates that the taxes associated with real estate property 10b are delinquent. Therefore, a tax notice should be posted on the real estate property so that the foreclosure process can be initiated. Prior to posting the tax notice, a field representative needs to be provided with the tax notice itself and certain delinquent tax information derived from the delinquent tax record such as the location of the real estate property where the tax notice is to be posted.

In order to provide this delinquent tax information, the portable computer device can be in communication with the tax authority's computer system 22. Computer readable instructions embodied in the computer readable medium of the portable computer device can, when actuated through a processor, retrieve delinquent tax information from the tax authority's computer system and store such information in the computer readable medium of the portable computer device.

The portable computer device can be in communication with the tax authority's computer system through a wireless system 30 including such systems as a cellular network, public switched telephone network, radio, satellite network or other such wireless communications networks. For example, in one embodiment, the portable computer device is a PDA 14 having a computer readable medium 16 in communication through a cellular network. In another embodiment, portable computer device can be a laptop, tablet or other such computing device 18 having computer readable medium 20.

The portable computer device can have a digital capture device such as a digital camera, either integrated with the portable computer device or attached to the portable computing device. Computer readable instructions embodied in the computer readable medium of the portable computer device can retrieve the date and time from the system information of the portable computer device when an image is captured so that the date and time that the image is captured can be associated with the digital image and stored in the computer readable medium. Alternately, a digital image can be uploaded to the portable computer device and the digital image would have a date and time associated with the digital image file.

In one embodiment, the portable computer device is GPS-enabled so as to receive GPS coordinates representing the current location of the portable computer device. In one embodiment, GPS coordinates are retrieved from GPS system 32 when the digital image is captured and the GPS coordinates are associated with the digital image. Therefore, in this embodiment, when the digital image is captured, the date, time, and location of the portable computer device is recorded and associated with the digital image. Subsequent retrieval of this information allows the viewer to see the digital image of the posted tax notice, the date and time that the tax notice is shown placed on the real estate property and the location of the portable computer device when the digital image of the tax notice is captured. The digital image, date and time, and GPS information can be included in posting information that is associated with the real estate property having delinquent taxes. The posting information can be transmitted back to the tax authority or posting server and the associated delinquent tax records can be updated to reflect that the real estate property has been posted.

In order for the field representative to post and record the posting of a tax notice, certain information, such as the physical address of the real estate, should be provided to the field representative. The tax authority maintains delinquent tax records wherein each record contains delinquent tax information representing that the real estate has delinquent taxes. This information is stored on computer readable medium 24. In one embodiment, computer readable instructions reside on the tax authority's server 22 for retrieving delinquent tax information from computer readable medium 24 and formatting the delinquent tax information to be retrieved or transmitted to the computer portable device. Once the delinquent tax information is received by the portable computer device, the field representative will have the information used to post and record the posting of the target real estate property.

In another embodiment, a posting server 28 is in communication with the tax authority's computer system. Computer readable instructions embodied in the computer readable medium of the posting server can retrieve delinquent tax records from computer readable medium 24 and make the necessary formatting changes to the delinquent tax records so that delinquent tax information derived from the delinquent tax records can be retrieved by or transmitted to the portable computer device. Communications between the tax authority's computer system, the posting server, and the portable computer device can be through WAN 36, LAN, 26, wireless communications networks, or any combination.

In one embodiment, a printing device can be connected to the posting server or the portable computer device. Through the printing device, tax notices themselves can be printed according to the delinquent tax information so that the field representative is provided with the delinquent tax information as well as a tangible copy of a tax notice that can then be posted on the real estate property. By allowing the tax notice to be printed as another location other than the tax authority, efficiencies in time and resources are realized since the field representative needs not travel to the tax authority to pick up tax notices.

Further, computer readable instructions embodiment on the computer readable medium of the tax authority's computer system, posting server or portable computer device can provide additional functionality for the benefit of the tax authority and the field representative. For example, computer readable instructions can segregate the delinquent tax records between several field representatives based upon such factors as workload or routes. For example, a first field representative may have had one hundred real estate properties to post. However, the first field agent has not transmitted posting information so that the delinquent tax information reflects only that the real estate properties are in need of posting and the first field agent needs to complete these one hundred postings. The computer readable instructions would then provide the delinquent tax information to the next field agent who did not have so many posting outstanding. In another embodiment, the computer readable instructions segregate delinquent tax information by physical allocation or route. Therefore, when the delinquent tax information is provided to the field representative, the information is organized to facilitate the physical travel between the various real estate properties that need tax notices posted. For example, delinquent tax information associated with real estate property 10a can be provided as the first real estate property that needs to be posted. Once the field representative posts the tax notice and generates the posting information, the portable computer device can inform the field agent that the next real estate property to visit is property 10b. Computer readable instructions can determine the next real estate property to visit using the physical addresses from the delinquent tax records, determining a travel route 12 and displaying the next property on the route to the field representative.

Once the field representative posts and generates posting information for one or more real estate properties, the posting information can be transmitted to the posting server or the tax authority based upon the embodiment. With the posting information, the real estate property information can be updated to reflect that the tax notice has been posted and the posting information provides evidentiary proof of when the property was posted with a digital image of the tax notice on the property.

The tax authority's computer system 22 can then update the tax information for the target property with the posting information to reflect that the notice was posted on the target property. The tax server can also maintain the posting information and associate the posting information with the target property tax information so that posting information can be retrieved for the target property.

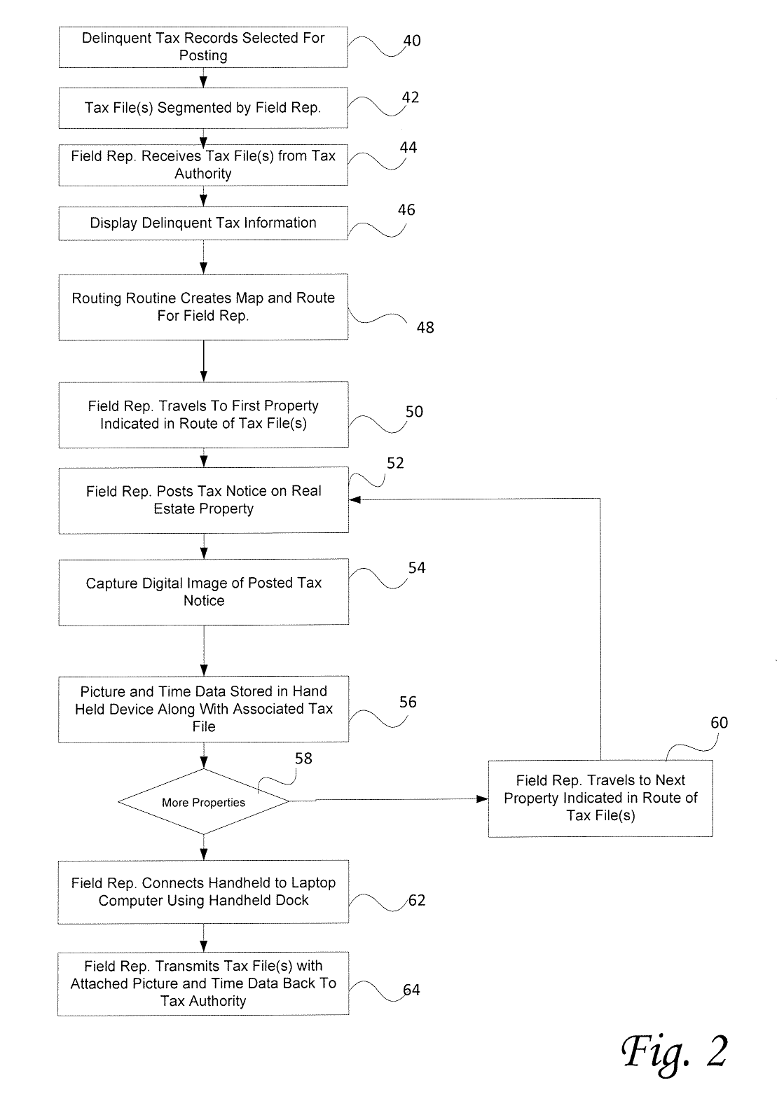

Referring now to FIG. 2, a method of performing this invention is shown. When a property owner fails to pay the taxes due upon a property and overdue notices fail to produce payment, the taxing authority indicates in the associated tax information that the property needs to be posted for foreclosure and tax sale. Once a property is delinquent and a determination by the tax authority that the property should be posted, computer readable instructions select the associated delinquent tax records at 40. When several delinquent tax records are selected, they can be segmented at step 42 to associate a specific posting with a specific field representative. Field representatives can be assigned by geographic area, date, deficiency amount or other criteria. After segmenting, the field representative receives the corresponding tax files at step 44. These tax files can be received and stored on the portable computer device and the associated computer readable medium.

After receiving the delinquent tax information, the next property to be posted can be displayed for the field agent at 46. A set of routing instructions can create a map and route at step 48 for the field representative to follow representing the travel path and map of the target property to post a tax notice.

Having the delinquent tax information for the property to be posted, the field representative travels at 50 to the first target property indicated in the route. At the first property, the field representative posts a tax notice upon the property and then at step 52. The field agent then takes a digital image of the tax notice posted on the real estate property at 54. This image can be associated with GPS coordinates and a date and time stamp indicating the location of the image and the time the image was acquired. In one embodiment, the field agent can provide a digital signature that can be associated with the posting information including the digital image. The image and associated posting information is associated with the tax file and stored in a computer readable medium at step 56.

Computer readable instructions stored in a computer readable medium upon the handheld device determines at step 58 whether additional properties are to be posted by this field representative. If additional properties remain, the field representative travels to the next property indicated by the computer readable instructions according to the route of tax files at step 60 and the process returns to step 52.

After all postings are complete, the field representative can then transmit the posting information at 62 to the taxing authority. In an alternative embodiment, the posting information is transmitted to the posting server.

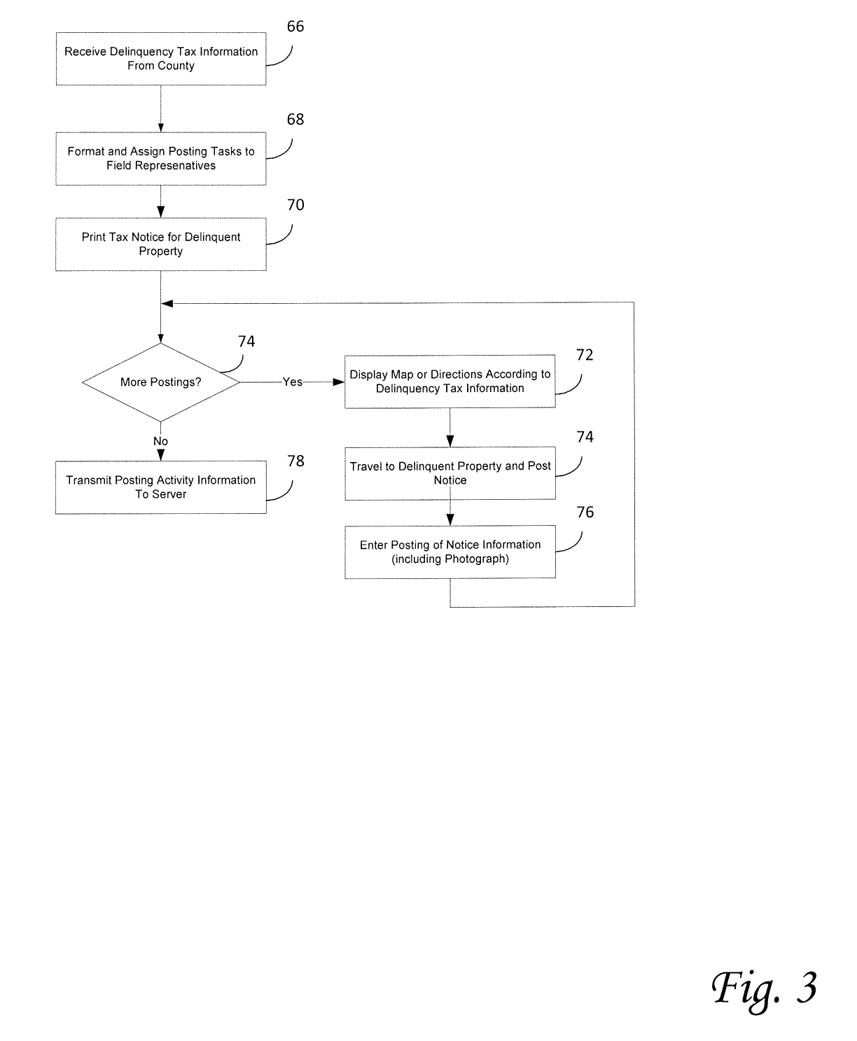

Referring to FIG. 3, the invention is descried in more detail. At 66, delinquent tax records are retrieved from the tax authority that needs to be posted. The retrieved records are formatted for transmission to the field representatives and can be segregated between different field agents at 68. A tax notices can be printed by the field agent at 70 for posting on the real estate properties on the assigned route.

A determination is made at 74 to determine if there are more postings to be performed. If the answer is yes, the travel route to the real estate property can be displayed at 72. The field agent travels to the real estate property at 74. The tax notice is posted at 76 and the digital image, date, time, GPS, and electronic signature can be included for generating the posting information. The process then returns to step 74. If at 74 there were no more postings, the posting information is transmitted back to the tax authority at 78.

Once the posting information is transmitted back to the taxing authority, the taxing authority can then either update the tax file associated with the target property to indicate that it was posted and can associate the posting information with the digital image with the tax file. Therefore, any user of the tax authority can subsequently retrieve the target property and the posting information can be viewed. This allows for the process of posting a tax notice on a property to be collected, recorded, and provided to the tax authority without the need for printed forms or Polaroid photographs being used by the field representative.

Therefore, this invention allows for the automation of the posting process and can reduce the error of the field representative since the route information, map, digital image, GPS, date, time, and electronic signature information are all integrated and associated with the target property information. Therefore, there is a reduced likelihood that the information will be incorrect and thus a reduction in the errors which can be caused by the field representative. For example, the GPS information, and the date and time stamp information will be automatically attached to the posting information rather than requiring input by the field representative.

This invention has been described in a manner to allow one skilled in the art to understand and practice the invention. The examples and embodiments used in this description are not to be used to limit the scope of the following claims.

What is claimed is:

1. A computerized tax notice posting and recording system for coordinating and administrating physical tax postings comprising:
establishing electronic communications between a server and a taxing authority computer system;
retrieving a first set of delinquent tax records from the taxing authority computer system wherein each delinquent tax record represents physical real estate property having a physical location;
storing the first set of delinquent tax records on the server remote from the taxing authority computer system;
providing a set of portable computer device instruction for installation on a portable computer device used by a field representative;
establishing electronic communications between the portable computer device and the server;
retrieving a second set of delinquent tax records from the server wherein the second set of delinquent tax records is derived from filtering the first set of delinquent tax records based upon the particular field representative receiving the second set of delinquent tax records;
storing each delinquent tax record from the second set of delinquent tax records in the portable computer device;
associating a physical tax notice with each delinquent tax record of the second set of delinquent tax records;
selecting a delinquent tax record from the second set of delinquent tax records stored on the portable computer device;
displaying a physical address associated with the retrieved delinquent tax record on the portable computer device with the physical location of the portable computer device;
identifying the physical tax notice associated with the delinquent tax record;
determining the present physical location of the portable computer device;
capturing an image of the physical tax notice physically placed at the physical address associated with the retrieved delinquent tax record on the portable computer device;
determining a travel route according to the second set of delinquent tax records
displaying a first property address on the portable computer on the route to the field representative.
creating posting information that includes an image of the physical tax notice placed on the real estate at the physical location of the portable computing device, date and time information retrieved from the computer readable portable computer device, the present physical location of the portable computer device, and a digital signature associated with the field representative;
transmitting the posting information to the server if the electronic communications between the portable computer device and the server remains established and updating the posting information for subsequent transmission to the server is the electronic communications between the portable computer device and the server is no longer established; and,
transmitting the posting information to the taxing authority computer system to provide a physical record of the physical tax notice posting on the associated real estate property for use in a foreclosure process.

2. The computerized tax notice posting and recording system of claim 1 including:
a travel route between the physical real estate properties of the second set of delinquent tax records;
displaying a first stop of the travel route on a display of the portable computer device for viewing by a field representative; and,
displaying a second stop of the travel route on a display of the portable computer device once the posting information associated with the first delinquent tax record is created.

3. The computerized tax notice posting and recording system of claim 1 including:
providing a portable printing device in communication with the portable computer device; and,
creating the physical tax notice for each real estate property represented by the second set of delinquent tax records.

4. The computerized tax notice posting and recording system of claim 1 including updating the delinquent tax record reflecting that posting information has been received for said selected delinquent tax record and transmitting the updated delinquent to record to the server.

5. The computerized tax notice posting and recording system of claim 4 including updating a delinquent tax record of the first set of delinquent tax records from the taxing authority computer system reflecting that posting information has been received for the delinquent tax record.

6. The computerized tax notice posting and recording system of claim 1 wherein retrieving the first set of delinquent tax records from the taxing authority computer system including receiving the first set of delinquent tax records by electronic mail.

7. The computerized tax notice posting and recording system of claim 1 including formatting each delinquent tax record from the second set of delinquent tax records for use by the set of portable computer device instructions.

8. The computerized tax notice posting and recording system of claim 1 wherein the posting information includes a map showing the location of the physical real estate property and the placement of the physical tax notice.

9. A computerized tax notice posting and recording system for coordinating and administrating physical tax postings comprising:
retrieving a first set of delinquent tax records from a taxing authority computer system wherein each delinquent tax record represents physical real estate property having a physical location;
providing a set of portable computer device instruction for installation on a portable computer device used by a field representative;
establishing electronic communications between the portable computer device and the server;
retrieving a second set of delinquent tax records from the server wherein the second set of delinquent tax records is derived from filtering the first set of delinquent tax records based upon the particular field representative receiving the second set of delinquent tax records;
storing each delinquent tax record from the second set of delinquent tax records in the portable computer device;
creating a physical tax notice and associating each tax notice with each one of the delinquent tax records of the second set of delinquent tax records;
selecting a delinquent tax record from the second set of delinquent tax records stored on the portable computer device;
displaying a physical address associated with the retrieved delinquent tax record on the portable computer device with the physical location of the portable computer device;
placing the physical tax notice associated with the delinquent tax record at the physical real estate property;
determining the present physical location physical real estate property using the portable computer device;
capturing an image of the physical tax notice physically placed at the physical address associated with the retrieved delinquent tax record;
creating posting information that includes an image of the physical tax notice, the physical location of the portable computing device, and date and time information retrieved from the computer readable portable computer device;
transmitting the posting information to the taxing authority computer system to provide a physical record of the physical tax notice posting on the associated real estate property for use in a foreclosure process.

10. The computerized tax notice posting and recording system of claim 9 including transmitting the posting information to the server if the electronic communications between the portable computer device and the server remains established and updating the posting information for subsequent transmission to the server is the electronic communications between the portable computer device and the server is no longer established.

11. The computerized tax notice posting and recording system of claim 9 including providing a portable printing device in communication with the portable computer device for creating the physical tax notice.

12. The computerized tax notice posting and recording system of claim 11 including providing the physical tax notice.

13. The computerized tax notice posting and recording system of claim 9 including updating the delinquent tax record reflecting that posting information has been received for the selected delinquent tax record and transmitting the updated delinquent tax record to the server.

14. The computerized tax notice posting and recording system of claim 13 including providing delinquent tax record that have not received posting information in the second set of delinquent tax records.

15. The computerized tax notice posting and recording system of claim 9 including formatting each delinquent tax record from the second set of delinquent tax records for use by the set of portable computer device instructions.

16. The computerized tax notice posting and recording system of claim 9 wherein the posting information includes a map showing the location of the physical real estate property and the placement of the physical tax notice.

17. A computerized tax notice posting and recording system for coordinating and administrating physical tax postings comprising:
retrieving a first set of delinquent tax records from a taxing authority computer system wherein each delinquent tax record represents physical real estate property having a physical location;
providing a set of portable computer device instruction for installation on a portable computer device used by a field representative;
establishing electronic communications between the portable computer device and a remote server;
retrieving a second set of delinquent tax records from the server wherein the second set of delinquent tax records is derived from filtering the first set of delinquent tax records based upon the particular field representative receiving the second set of delinquent tax records;
creating a physical tax notice and associating each tax notice with each one of the delinquent tax records of the second set of delinquent tax records;
selecting a delinquent tax record from the second set of delinquent tax records stored on the portable computer device;
placing the physical tax notice associated with the delinquent tax record at the physical real estate property;
creating posting information that includes a digital image of the physical tax notice captured with the portable computing device, the physical location of the physical property captured by the portable computing device, the date and time information captured from the computer readable portable computer device and field representative information retrieved from the portable computer device; and,
transmitting the posting information to the taxing authority computer system to provide a physical record of the physical tax notice posting on the associated real estate property for use in a foreclosure process.

18. The computerized tax notice posting and recording system of claim 17 wherein the posting information includes a map showing the location of the physical real estate property and the placement of the physical tax notice.

19. The computerized tax notice posting and recording system of claim 17 including displaying a map showing the location of the physical real estate property where the physical tax notice is to be placed.

20. The computerized tax notice posting and recording system of claim 17 including providing a portable printing device for creating the physical tax notice.
